(19) United States
(12) Patent Application Publication
(10) Pub. No.: US 2010/0321507 A1
(43) Pub. Date: Dec. 23, 2010

(54) Media Source Selection Based On Source Quality

(76) Inventors: Christopher W Larsen, Houston, TX (US); Jonathan A. Kaye, Tomball, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/866,284

(22) PCT Filed: Mar. 10, 2008
(86) PCT No.: PCT/US08/56407

§ 371 Date: Aug. 5, 2010

(51) Int. Cl. H04N 17/00

(52) U.S. Cl. 348/192; 348/E17.004

(57) ABSTRACT

A computer-implemented method comprises determining which of a plurality of media sources has a higher quality than at least one other media source and selecting the media source having the higher quality.

### BACKGROUND

Television broadcasts are distributed free over the air (FOA) as well as via other sources such as cable television (CATV), satellite television (SATV) and even the Internet. As such, a viewer using a mobile device such as a notebook computer equipped to receive multiple media signals (FOA, CATV, etc.) may have access the same broadcast from multiple different sources. However, selecting a particular media signal source can be cumbersome. Further, a suitable choice for the media signal may depend on the location of the mobile device. For example, if the mobile device is located inside a building, the FOA signal may be of inferior quality compared to an Internet source.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 illustrates a cross-referenced media list table in accordance with various embodiments; and

FIG. 3 shows method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

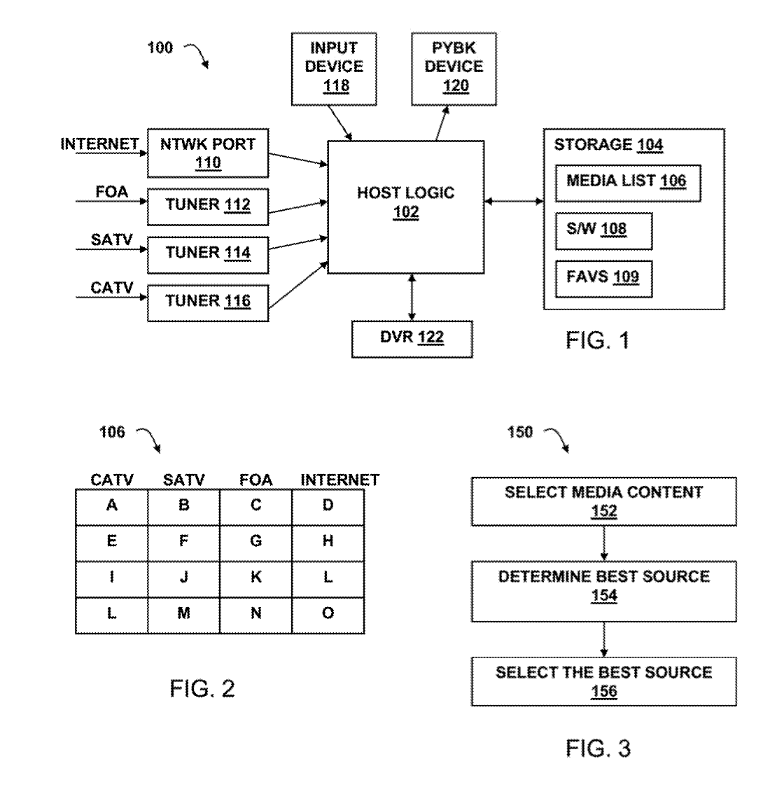

FIG. 1 shows a computer 100 in accordance with various embodiments. As shown, the computer 100 comprises a host logic 102 and storage 104, an input device 118 (e.g., a keyboard), a playback device 120, a digital video recorder (DVR) 122, a network port 110 and tuners 112-116. The playback device 120 comprises a display and/or a speaker through which audio-visual broadcasts (e.g., television programs) can be played to the user. The DVR 122 can be used to record such broadcasts as desired by the user of the computer 100. The computer 100 may comprise a portable device such as a notebook computer, although computer 100 need not be portable (e.g., a desktop computer), and in general may be any type of playback device by which media content can be played and/or recorded.

The storage 104 comprises a computer-readable medium (CRM) containing volatile storage (e.g., random access memory (RAM)), non-volatile storage (e.g., read-only memory, hard disk drive, Flash memory, etc.), or combinations thereof. As shown, the storage 104 comprises a media list 106 and software (SAN) 108. The software 108 comprises code that is executable by the host logic 102 and provides the computer 100 with some, or all, of the functionality described herein. The host logic 102 comprises a processor and, as desired, other circuitry.

The computer 100 can connect to a network such as the Internet via a network port 110. The network port 110 may enable a wired network connection to the computer or alternatively a wireless connection to a wireless access point or other type of wireless network connectivity device. Via the network port 110, the computer 100 receives television broadcasts streamed over the Internet.

Each of the tuners 112-116 is used to enable a user of the computer 100 to select (tune) a corresponding type of media signal to a desired channel. For example, tuner 112 is used to receive a free over the air (FOA) signal such as the Advanced Television Systems Committee (ATSC) signal. Tuner 114 is used to receive a satellite television (SATV) signal and tuner 116 is used to receive a cable television (CAN) signal. Any of the tuners 112-116 may be part of the computer 100 or may be part of a separate set top box to which the computer 100 has a wired or wireless connection.

Thus, via the network port 110 and tuners 112-116, the computer 100 can receive multiple media sources and thus can receive the same broadcast (e.g., a television program) via multiple media sources. In general, the computer 100, via software 108, determine which of the various available media sources has a higher quality than at least one or more other media sources. Such “quality” includes transmission quality, signal quality (digital may be considered a higher quality than analog or a higher resolution format signal may be considered a higher quality than a lower resolution format signal). Once that determination is made, the computer, via software 108, selects the media source that is determined to have the higher quality. This particular media source is selected for purposes of being played to the user via playback device 120 and/or recorded via DVR 122.

In some cases, the user of computer 100 may know a particular broadcast that the user desires to watch or record. The user specifies to the computer, via input device 118, the identity of the broadcast and the associated media source to be viewed or recorded. For example, the user may specify a particular news program on a specific CATV channel. The computer 100 uses the media list 106 in storage 104 to obtain a cross-reference of the specified media source and channel to the other media sources to determine all available sources of the specified broadcast.

FIG. 2 illustrates an embodiment of the media list 106. Each row in the media list pertains to a common channel or broadcast. The letters in the media list represent specific channels in the associated media source. The letter designations for the Internet may comprise Internet Protocol (IP) addresses or Uniform Resource Locators (URLs) rather than channels per se. By way of example, the first row shows that channel A on CATC corresponds to channel B on SATV, channel C on FOA, and IP/URL D on the Internet. As such, any of these channels/network designations can be selected to view or record a particular broadcast. The second row illustrates that channels E, F, and G of CATV, SATV and FOA, respectively, as a well network designation H on the Internet correspond to each other. While media list 106 in FIG. 2 has four rows of corresponding channel/network designations, any number of corresponding channel/network designation sets can be provided in the media list. Further, a given broadcast may be available on only one media source, or alternatively one some but not all of the available media sources. Thus, if a broadcast is only available on CATC and over the Internet, then the media list 106 will only show this correspondence. The media list 106 may be pre-stored in storage 104 at the factory, downloaded over the Internet from a network service that cross-references the various broadcasts or created by the user of the computer 100.

When a user selects a particular broadcast to view or record, the computer 100 (via software 108) examines the media list 106 to determine all available media sources that have the specified broadcast. The host logic 102 then determines, of the various media sources having the specified broadcast, which media source is best, that is, has the highest quality. Measuring relative quality can be performed in a variety of ways. For example, signal strength of the CATV, SATV and FOA signals can be measured and compared to each other. In the case of the network connection to the Internet, bit error rate can be measured, and compared to the signal strength of the CATV, SATV and FOA signals (a suitable conversion may be implemented to compare bit error rate to signal strength). Additional detail may be found at U.S. Pat. Nos. 6,252,547 and 6,931,577, incorporated herein by reference. The host logic 102 (FIG. 1) may include circuitry that receives and compares the various signals as discussed above. Quality can also be a function of the bit rate of different digital signals. A higher bit rate signal may be considered higher quality than a lower bit rate signal.

FIG. 3 illustrates a corresponding method 150 that is performed by the host logic 102 executing software 108. At 152, the method comprises selecting media content to be viewed or recorded. At 154, the best (i.e., highest quality) available source for the selected media content is determined. At 156, the source determined to be best is selected for viewing or recording as desired by the user.

Because computer 100 may be portable, the computer may be relocated while playing or recording a broadcast. The relocation of computer 100 may result in a different media source from that currently selected as being the media source that is now the best (highest quality). As such, computer 100 repeatedly re-evaluates which available media source has the highest quality and, as necessary, switches from media source to another. For example, if the user may be outside with the computer 100 which is receiving the FOA media signal (determined at the time to have the highest quality relative to the other media signals for the broadcast being viewed). The user may decide to go inside at which point, the FOA signal may fade and the Internet source may be the media signal with the highest quality. The computer 100 detects this change and switches automatically from one media source (FOA in this example) to another media source (e.g., Internet). The re-evaluation by the computer 100 may be performed at periodic intervals (once per minute) or upon command by the use via input device 118.

Referring again to FIG. 1, in some embodiments, the user can create a “favorites” list (FAVS) 109 of broadcasts/channels. The favorites list includes one or more broadcasts/channels the user specifies (presumably, but not necessarily as being desired by the user to view/record). The user can select any of the broadcasts specified in the favorites list.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer-implemented method, comprising:
determining which of a plurality of media sources has a higher quality than at least one other media source; and
selecting the media source having said higher quality.

2. The computer-implemented method of claim 1 further comprising selecting a media content available on the plurality of media sources.

3. The computer-implemented method of claim 1 further comprising specifying broadcast content available on each of said media sources.

4. The computer-implemented method of claim 1 further comprising playing said selected media source.

5. The computer-implemented method of claim 1 further comprising recording said selected media source.

6. The computer-implemented method of claim 1 further comprising repeatedly determining which of the plurality of media sources has a higher quality than at least one other media source and selecting the media source having said higher quality while a media content from one of said media sources is playing or recording.

7. The computer-implemented method of claim 1 further comprising switching from one media source to another while said media content is playing.

8. The computer-implemented method of claim 1 wherein determining which of the plurality of media sources has a higher quality than at least one other media source comprises comparing signal strength or bit error rate.

9. A system, comprising:
a plurality of interfaces, each interface receiving one or more media source signals;
logic that determines which of the media source signals has a higher quality than at least one other media source signal and selects the media source signal having said higher quality.

10. The system of claim 9 further comprising a media content cross-reference listing, accessible to said logic, that cross-references media content among the plurality of media source signals.

11. The system of claim 9 wherein the logic selects the media source signal having said higher quality for playback.

12. The system of claim 9 wherein the logic selects the media source signal having said higher quality for recording.

13. The system of claim 9 further comprising an input device through which a user of the system selects media content for which the logic determines which of the media source signals has a higher quality.

14. The system of claim 9 wherein the logic determines quality of the media source signals based on a criteria selected from a group consisting of signal strength, bit error rate, and bit rate.

15. The system of claim 9 wherein the system comprises a notebook computer.

16. The system of claim 9 wherein the logic switches from a first media source signal to a second media source signal while playing or recording the first media source signal.

17. A computer-readable medium (CRM) containing software that, when executed by a processor, causes the processor to:
enable a user to select a broadcast; and
determine which of a plurality of media sources containing said selected broadcast has a higher quality than at least one other media source.

18. The CRM of claim 17 wherein the software further causes the processor to select the media source having said higher quality.

19. The CRM of claim 17 wherein the media sources comprise any a group selected from a network, a free over-the-air signal, cable television, and satellite television.

20. The CRM of claim 17 wherein the software enables the user to select the media source having the higher quality for viewing or recording.
